(19) United States
(12) Patent Application Publication
(10) Pub. No.: US 2023/0215409 A1
(43) Pub. Date: Jul. 6, 2023

(54) INTERCHANGEABLE TRANSDUCER SYSTEM FOR ELECTRIC MUSICAL INSTRUMENTS

(71) Applicant: Mark Ellis Stevens, Arlington, WA (US)

(72) Inventor: Mark Ellis Stevens, Arlington, WA (US)

(21) Appl. No.: 17/646,802

(22) Filed: Jan. 3, 2022

(51) Int. Cl. G10H 3/18

(52) U.S. Cl. CPC G10H 3/183; G10H 3/182; G10H 3/181; G10H 2220/461

(57) ABSTRACT

An interchangeable transducer system for electrical musical instruments, wherein the system embodies one or more transducer cavities formed into the musical instrument, wherein self-contained transducers can slide into and out of each transducer cavity. Thereby the same instrument can generate vastly different tonal qualities depending on the type of self-contained transducers the user interchanges within each transducer cavity.

### BACKGROUND OF THE INVENTION

The present invention relates to musical technology and, more particularly, an interchangeable transducer system for electrical musical instruments.

In music technology, a “pickup” is a transducer that captures or senses mechanical vibrations produced by musical instruments, particularly stringed instruments such as the electric guitar, and converts these to an electrical signal that is amplified to produce musical sounds through a loudspeaker and/or recorded.

Pickups typically include conductors (e.g., copper wires) coiled around magnets, wherein each magnet is associated with each string of a string instrument. The number of coils, the gauge of the conductors, the polar orientation of the magnets, and the output hookup can all determine the final tone produced and captured through the pickup. One obvious example is the humbucker or double coil pickup, which uses two coils that are essentially in series (e.g., the plurality of pickup magnets connected end to end)m while another example is a parallel arrangement (the plurality of pickup magnets connected across each other) predominantly associated with the Stratocaster™ guitar.

These two arrangements produce different tonal qualities for the same notes strummed. Furthermore, the arrangement of two or more pickup vis-à-vis each also effect the final tonal signature of the sensed mechanical vibrations. For example, each pickup has a specific phase (as a function of the magnet orientation and/or the output connection), and when two out-of-phase pickups are used in conjunction, the resulting sound is much different than if those same two pickup were otherwise identical though in phase. That is not to say one sound is “better” than the other, as that is in the ear of the beholder. And, in fact, artist are constantly looking to create or recreate new or classic tonal experiences with the same instrument.

Which is the point of the present invention, as currently for conventional electric string instruments the pickup arrangement is fixed in place—i.e., the pickups are hardwired into the guitar. As a result, it is very difficult and expensive to change a guitar tone, which is why guitarist find it easier to buy another expensive guitar.

As can be seen, there is a need for an interchangeable transducer system for electrical musical instruments. The interchangeable transducer system embodied in the present invention (colloquially known as the “Lovecraft system”) allows the pickups to be removed and replaced by sliding each in and out of recesses, whereby the user of the system can selectively change the tone generated by the same unchanged strings through changing the arrangement of the pickups. As a result, guitarist do not have to own several guitars to get different sounds/tones; rather they can simply replace a first tone generator pickup by sliding it out and sliding another second tone generator pickup in. Thus, the guitar's tones can be changed in seconds; currently, most musicians would have to take their instrument to the guitar shop, where the fee is often $100 plus the cost of materials. And even if they could do it themselves, a convention electric guitar would normally take hours to make the changes that the present invention can accomplish in seconds.

### SUMMARY OF THE INVENTION

In one aspect of the present invention, transducer system for a musical instrument, the system includes one or more transducer cavity in a body of the musical instrument; and each transducer cavity has a receiving end dimensioned to slidable receive a transducer under a plurality of strings of the musical instrument when said plurality of strings are operatively associated with the body of the musical instrument.

In another aspect of the present invention, a. system of claim 1, wherein each transducer cavity has a connecting end opposite the receiving end, wherein the connecting end provides one or more connection points for electrically coupling to the transducer, wherein each receiving end has a ramp that transitions from a front surface 40 of the musical instrument to a base surface extending to the connecting end, wherein the ramp has a slope of between thirty and sixty degrees relative to two planes associated with the front surface and the base surface, wherein an edge 50 of the receiving end of one transducer cavity of the one or more transducer cavities is subjacent a front surface of the musical instrument, wherein the receiving end is a receiving distance from said plurality of strings, wherein the connecting end is a connecting distance from said plurality of strings, wherein the receiving distance is at least one inch greater than the connecting distance, and wherein the receiving and connecting distances are orthogonal to a direction of the plurality of strings; and a plurality of transducers, each transducer having a tonal difference selected from the group including a substantial difference in (a) a number of coils, (b) an orientation of a plurality of pickup magnets, (c) the plurality of pickup magnets connected across each other, and (d) the plurality of pickup magnets connected end to end, whereby the plurality of transducers is interchangeable within the one or more transducer cavities; and a fastener point on a rear surface instrument, wherein the fastener point communicates with the base surface.

These and other features, aspects and advantages of the present invention will become better understood with reference to the following drawings, description and claims.

### BRIEF DESCRIPTION OF THE DRAWINGS

FIG. 1 is a front perspective view of an exemplary embodiment of the present invention, shown in use.

FIG. 2 is a front perspective view of an exemplary embodiment of the present invention, with the guitar strings removed for clarity.

FIG. 3 is a rear perspective view of an exemplary embodiment of the present invention, illustrating the attachment points for fastening the pickup.

FIG. 4 is an exploded front perspective view of an exemplary embodiment of the present invention, illustrating the interchangeability of transducers.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides an interchangeable transducer system for electrical musical instruments, wherein the system embodies one or more transducer cavities formed into the musical instrument, wherein self-contained transducers can slide into and out of each transducer cavity. Thereby the same instrument can generate vastly different tonal qualities depending on the type of self-contained transducers the user interchanges within each transducer cavity.

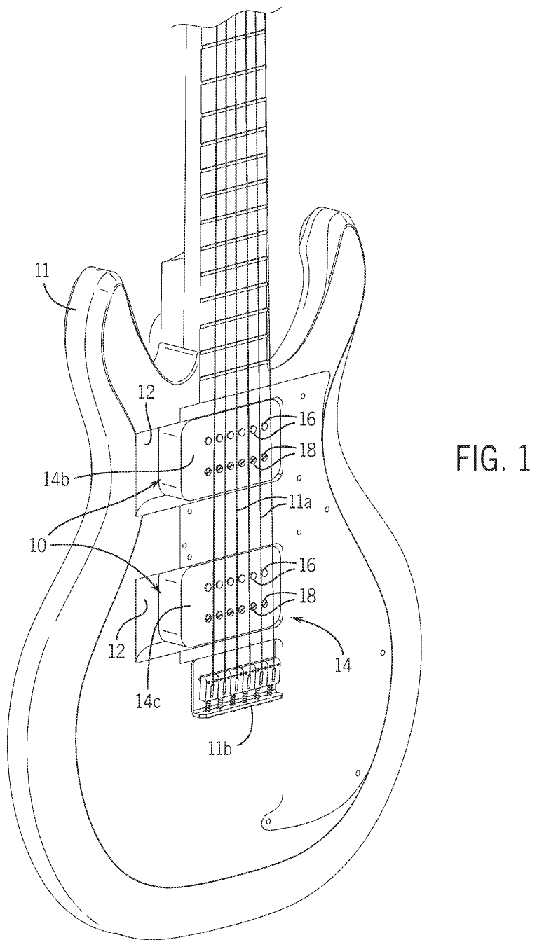

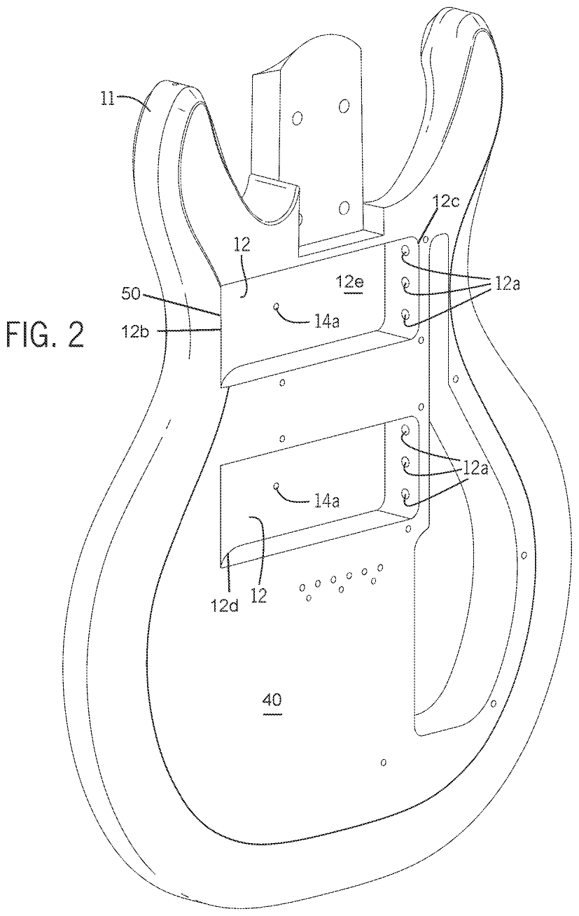

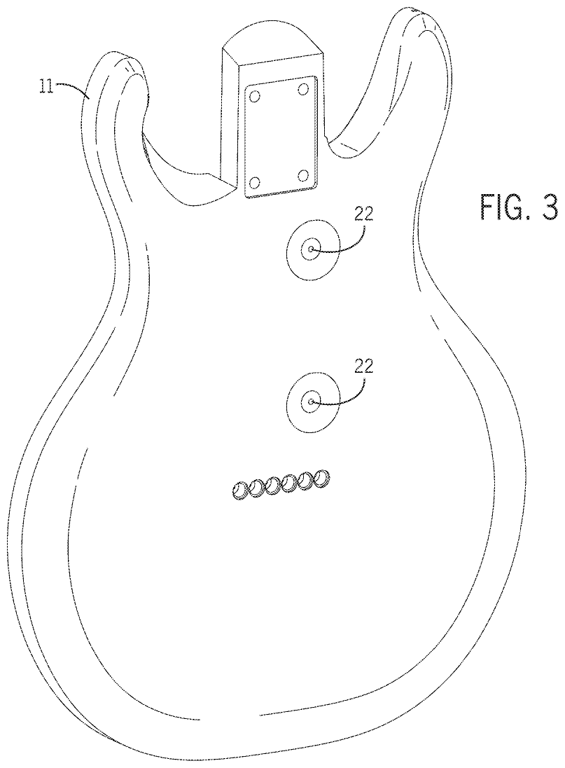

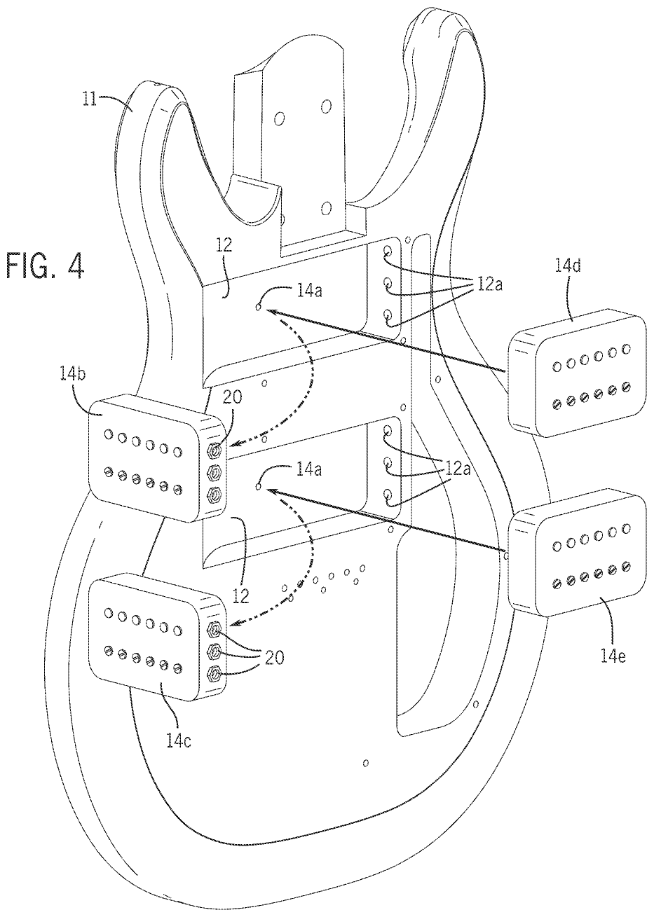

Referring now to FIGS. 1 through 4, the present invention may include an interchangeable transducer system 10 for an electrical musical instrument.

### ITEMIZED PARTS LIST

10: is the interchangeable transducer system.

11: is the instrument body.

11a: are the instrument strings.

12: are the cavities for the systemic transducers.

12a: are first connection points.

14: are the systemic transducers.

14a: are mounting holes for transducer.

14b: is the first transducer.

14c: is the second transducer.

14d: is the third transducer.

14e: is the fourth transducer.

16: are the magnets/pickups.

18: are the tone adjusters.

20: are second connection points.

22: are fastener points for magnets/pickups.

40 is the front surface cavities for the systemic transducers.

50 is an edge of the cavities for the systemic transducers.

The interchangeable transducer system 10 may include one or more transducer cavities 12 provided in an instrument body 11 subjacent the instrument strings 11a. Each cavity 12 may be dimensioned and adapted to slidably receive one of a plurality of systemic transducers 14. The transducer 14 may also be known as a pickup or even more colloquially as a “tone generator”. Each transducer 14 may have a body or bobbin that retains a plurality of spaced apart magnets/pickups 16, where each magnets/pickups 16 aligns subjacent a string 11a, when the systemic transducer 14 is attached in the cavity 12. The transducer 14 may provide tone adjusters 18 operatively associated with each magnets/pickup 16 so that the user can make adjustments to the tone without removing the transducer 14.

Each cavity 12 may have two opposing ends: a receiving end 12b and a connecting end 12c. From a plan view, the receiving and connecting ends 12b and 12c may not be symmetrical relatively the plurality of instrument strings 11a or their bridge 11b. For one, the receiving end 12b may extend an end distance from a midline of the bridge 11b that is greater than the end distance between that same midline and the connecting end 12c. This greater end distance is to accommodate sliding the transducer 14 in and out of the cavity 12. The receiving end 12b may have a ramp or slope 12d for facilitated this sliding underneath the strings 11a. The ramp/slope 12d may be between thirty and sixty degrees relative to the two planes associated with the front surface 40 of the musical instrument and the base surface 12e of the cavity. Though, it should be understood that the slope 12d of the ramp may be any positive number relative the two planes associated with the front surface 40 and the base surface 12e, respectively. The base surface 12e of the cavity extends to the connected end of the cavity. The base surface 12e may provide a mounting hole 14a that communicates with the rear surface of the instrument body 11a by way of fastener points 22, whereby a suitable fastener (not shown) may secure the transducer 14 into the cavity 12, and likewise when the fastener is loosened, the transducer 14 can slide from the cavity 12.

The connecting end 12c provides first electrical connection points 12a to operatively associate with the transducer 14, thereby electrically powering it by electrically connecting to second electrical connection points 20 along a periphery of the transducer 14. The first and second electrical connection points 12a and 20 may be socket type connections or any suitable plug and play electrical connection as disclosed herein.

Each musical instrument 11 may have at least one cavity 12, through may have two or more cavities 12 to enable creating different arrangement of transducers 14. Even with two cavities 12, and a kit of a first transducer 14b, a second transducer 14c, a third transducer 14d, and a second transducer 14e, wherein each transducer has a different tonal signature as a function of its arrangement and/or types of transducer components—e.g., magnets 16, coils (not shown), and the like—wherein each transducer may have a different gauge of coil, a different number of turns of the coil, different electrical arrangement of double coils (series or parallel), and/or different orientation of the magnets), many permutations and thus tonal sounds generated by mixing and matching. The musical instrument 11 could have three cavities 12, even though that is not shown in the figures. Likewise, the musical instrument 11 could have one or more fixed transducers and one cavity 12 in which one of the four different tone generators (transducer 14b, 14c, 14d, and 14e) can be interchanged on demand.

In other words, the musician would have many types of guitars in one.

It should be understood, of course, that the foregoing relates to exemplary embodiments of the invention and that modifications may be made without departing from the spirit and scope of the invention as set forth in the following claims.

What is claimed is:

1. A transducer system for a musical instrument, the system comprises:
one or more transducer cavity in a body of the musical instrument; and
each transducer cavity has a receiving end dimensioned to slidable receive a transducer under a plurality of strings of the musical instrument when said plurality of strings are operatively associated with the body of the musical instrument.

2. The system of claim 1, wherein each transducer cavity has a connecting end opposite the receiving end, wherein the connecting end provides one or more connection points for electrically coupling to the transducer.

3. The system of claim 2, wherein each receiving end has a ramp sloping from a front surface of the musical instrument to a base surface, wherein the base surface extends to said connecting end.

4. The system of claim 3, wherein the ramp has a slope of between thirty and sixty degrees relative to the two planes associated with the front surface and the base surface, respectively.

5. The system of claim 2, wherein an edge of the receiving end of one transducer cavity of the one or more transducer cavities is subjacent a front surface of the musical instrument.

6. The system of claim 2, wherein the receiving end is a receiving distance from said plurality of strings, wherein the connecting end is a connecting distance from said plurality of strings, wherein the receiving distance is at least one inch greater than the connecting distance, and wherein the receiving and connecting distances are orthogonal to a direction of the plurality of strings.

7. The system of claim 4, further comprising a plurality of transducers, each transducer having a tonal difference selected from the group consisting of a substantial difference in (a) a number of coils, (b) an orientation of a plurality of pickup magnets, (c) the plurality of pickup magnets connected across each other, and (d) the plurality of pickup magnets connected end to end, whereby the plurality of transducers is interchangeable within the one or more transducer cavities.

8. The system of claim 5, further comprising a plurality of transducers, each transducer having a tonal difference selected from the group consisting of a substantial difference in (a) a number of coils, (b) an orientation of a plurality of pickup magnets, (c) the plurality of pickup magnets connected across each other, and (d) the plurality of pickup magnets connected end to end.

9. The system of claim 6, further comprising a plurality of transducers, each transducer having a tonal difference selected from the group consisting of a substantial difference in (a) a number of coils, (b) an orientation of a plurality of pickup magnets, (c) the plurality of pickup magnets connected across each other, and (d) the plurality of pickup magnets connected end to end.

10. The system of claim 9, further comprising a fastener point on a rear surface instrument, wherein the fastener point communicates with the base surface.
